(19) United States
(12) Patent Application Publication
(10) Pub. No.: US 2012/0278105 A1
(43) Pub. Date: Nov. 1, 2012

(54) PROTOCOL GUIDED IMAGING PROCEDURE

(75) Inventors: Joseph M. Luszcz, Hudson, NH (US); Dawn Blythe Stowers, Reading, MA (US)

(73) Assignee: KONINKLIJKE PHILIPS ELECTRONICS N.V., EINDHOVEN (NL)

(21) Appl. No.: 13/510,387

(22) PCT Filed: Nov. 17, 2010
(86) PCT No.: PCT/IB10/55233

§ 371 Date: May 17, 2012

Related U.S. Application Data
(60) Provisional application No. 61/263,848, filed on Nov. 24, 2009.

(51) Int. Cl. G06Q 50/24

(52) U.S. Cl. 705/3

(57) ABSTRACT

The proposed method and apparatus simplifies the task of selecting diagnostic findings indicated by a medical image by constraining all the possible selections of diagnostic findings to those appropriate for the specific clinical context represented by an image being acquired or viewed. Further, the proposed method and apparatus makes available the clinical context represented by an image without overt action by the person acquiring the image by utilizing the concept of a predefined exam protocol containing a set of views each describing an image to be acquired, and including with each view the clinical context that is to be associated with each image acquired for that view. In other words, the proposed method and system allows making available for selection only those diagnostic findings that are clinically relevant to any one of the views.

### FIELD OF THE INVENTION

The invention relates to medical imaging protocol guidance of the generation of diagnostic reports and related imaging system behaviours. In particular, the invention relates to a method and apparatus for protocol guided diagnoses.

### BACKGROUND OF THE INVENTION

Medical examinations of patients have come to rely more and more on complex, highly dedicated and expensive medical imaging equipment. Medical imaging equipment, also known as “medical imaging modalities”, includes X-ray, ultrasound and CT imaging systems.

Current imaging modalities are capable of providing high quality images of anatomical structures and physiological function. For example, in a vascular ultrasound exam, images of vessels are acquired which show the vessel structure (anatomy) as well as any plaque deposits that may be present and blood flow direction and velocity information (physiology) which are useful for determining if vessels are occluded and to what degree, whether venous valves are functional, and other important clinical information.

Using existing imaging equipment, the medical practitioner may take written or mental notes during image acquisition related to observations made as images are acquired. At the conclusion of an image acquisition procedure (“examination”) the medical practitioner would normally build a diagnostic report consisting of a number of diagnostic findings that inform the referring physician of the medical conditions discovered during the imaging exam. These diagnostic findings may be based on the written or mental notes taken during the exam, which may be vague or inaccurate recollections of what was actually observed during the exam and the association with specific images that led to each note is lost.

Alternatively, the diagnostic findings may be created during a complete re-review of all acquired images after image acquisition is done, but because captured images are only representative samples of all imagery seen by the operator during the exam, the broader context that led to the capture of specific images may be lost leading to less accurate conclusions. In each case, a separate process step is added to the exam time to review the notes and/or images and prepare the diagnostic report.

To ease the burden on the practitioner creating the diagnostic report, medical databases have been created for storing pre-defined “diagnostic findings” in form of codes defined in a medical vocabulary standard or in a locally-generated code set. Such medical databases comprise normally in the order of thousands of diagnostic findings, even when for a specific case such as a cardiac patient. Even if this information is organized hierarchically, there are still many choices that would need to be made when “drilling down” to a desired statement. This makes the creation of a diagnostic report during image acquisition impractical because of the time required to search through the numerous available findings to locate the desired code or codes. Even when the diagnostic report is created after image acquisition, report creation takes much of a medical practitioner's valuable time.

Further, this process does not provide the opportunity to create links for example between diagnostic findings and specific images that provide evidence for that statement.

### SUMMARY OF THE INVENTION

There is therefore a need in the art for means supporting and speeding up the process of logging relevant medical findings and to better align this process with the throughput capability of a modern imaging modality.

This invention leverages the concept of an “acquisition protocol” to address this dilemma. In general terms, an acquisition protocol is an agreed-upon plan of how a particular type of imaging exam is to be conducted. More specifically, in equipment terms a Protocol is a pre-defined set of steps to be performed to gather all required information comprising the medical imaging exam, and the performance of these steps are supported by and enforced by the imaging equipment.

The Protocol defines the characteristics of each image to be acquired and assists the user in setting the equipment properly in preparation for acquisition of each image. In particular, the protocol may specify the “clinical context” under which each image is to be acquired, which includes but is not limited to the specific anatomy and/or physiology to be scanned, the position and orientation of the imaging transducer, and the imaging mode to use. Further, the Protocol provides a prompt to the user as to the clinical context for image acquisition, additional imaging machine settings to use, the textual and graphical annotation that is displayed on the image, one or more quantitative measurements that must be taken, and other information relevant to the acquisition of the image. The plurality of all images acquired under control of the protocol provides the medical practitioner with the information he or she needs to formulate a diagnostic conclusion in the form of a diagnostic report.

The protocols are defined once, up-front, by medical experts for all exam types prior to an actual image acquisition. Each protocol is generally tailored to the specific type of exam to be acquired and allows image acquisition to make best use of capabilities of a specific imaging modality.

The invention addresses the above-identified needs by providing a method of processing a medical image acquired in a protocol guided imaging procedure. The method comprises identifying in the protocol the clinical context represented by the acquired image file in a machine readable fashion. At the time of image acquisition, the method then proceeds to copy the clinical context data from the protocol to the acquired image file so the clinical context is henceforth known for the acquired image.

The protocol specifies for example in a mark-up language each procedural step or “view”. The view identifies, e.g. by way of coordinate parameters, the specific clinical context represented by the image to be taken. A totality of the information in the protocol and the clinical context data in particular defines the clinical context represented by each acquired image.

The medical image file so created and having copied therein the clinical context data is a “smart” image because it has, upon its acquisition, descriptive information on the clinical context represented by its bit pattern. In other words, the smart image “knows” of the clinical context it represents.

“Copying the clinical context data” into the acquired image file to obtain a “smart” image is to be construed broadly. Copying may also include marking or simply adding a reference to the clinical context data.

The method further comprises using this clinical context data to regulate image review and processing behaviour in a manner appropriate for the clinical context. The method allows harnessing the clinical context data in the protocol to expedite subsequent post-processing steps to be performed on the acquired image files.

Post-processing steps addressed by the inventive method may include:
offering for selection by the medical practitioner suitable diagnostic findings useful for creating the overseeing medical practitioner's diagnostic report
making available suitable graphical annotation markers for inclusion with the image to highlight medical findings.
offering for selection by the medical practitioner checklists of visualized structures from which the operator may mark those structures that are in fact visualized in the representative image
customizing other similar system behaviors for which it would be beneficial to know the clinical context represented by the acquired image.

According to one embodiment the method comprises a step of filtering a database of candidate diagnostic findings. Filtering is by matching the clinical context data copied into the image file to indices of the stored diagnostic findings. Once one or more matches are detected, it is only the matching diagnostic findings that are provided to a user for selection in a graphical user interface. In this way a restricted view on the potentially vast number of available diagnostic findings is effected.

Once the user issues a command, for example by clicking with a pointer device such as a mouse on a graphical user interface, a further step is executed of linking the matched diagnostic finding to the image file. In this way a bundle or “tuple” is created comprising one image and one matched diagnostic finding. The so created data structure facilitates not only building the medical report but also subsequent offline review of the images. An association between the image file and the matching diagnostic finding may be effected by suitable paths or resource locators to effectively link the image to the matching diagnostic finding.

After the imaging procedure, the exam can be easily reviewed by evoking in suitable viewers the stored away image files. Upon viewing and clicking through the image files, or otherwise upon request by the reviewing physician, the matched and linked diagnostic findings are shown, for example in pop-ups on the screen along with the respective image file.

The selected diagnostic findings may, during acquisition, shortly after acquisition, or at a later stage, be compiled or assembled into a medical report.

The method also allows effecting a “scan together with a corresponding diagnostic report as you go” paradigm in that it allows the medical practitioner to carry out concurrently both the acquisition of required images and the creation of the diagnostic report. The expensive medical imaging equipment and the medical practitioner's time may therefore be used more efficiently.

Therefore, the key benefits of the method according to the invention are:
1) diagnostic observations made during acquisition are not forgotten
2) the operator's appreciation for all visualized images prior to the acquisition of the representative image, rather than just the acquired image itself, are considered in the collection of diagnostic observations
3) observations do not have to be entered into an information system as a separate (and potentially error-prone) post-processing step but may be gathered as they occur
4) links between acquired images and associated diagnostic findings discussed above are readily created
5) compared to current post-scanning diagnostic review, time required to “search” for appropriate diagnostic statements is reduced to such a degree that concurrent acquisition of images and creation of a diagnostic report is practical.

According to another embodiment, the method further allows having regard to at least one measurement value taken on at least one acquired image file when carrying out the filtering step to further constrain the number of suitable diagnostic findings. According to this embodiment of the present invention, the method further comprises comparing each measurement value taken against the normal range of values for that measurement to obtain a deviation value. The deviation value is then used to filter the diagnostic findings database for the most appropriate findings by matching both the clinical context data copied into the image file and the deviation value or values of measurements taken on the image.

The method hence allows the practitioner to select the diagnostic findings in a more targeted manner so as to have regard to the specific clinical context represented in the image file. According to one aspect of the present invention, the steps of comparing, filtering the database, and copying selected diagnostic findings occurs whilst the images are being displayed on a screen.

Those steps may also be executed for each individual image file immediately upon its acquisition or may be delayed to a later stage after conclusion of the acquisition session. Further, the steps may be performed on the device that had acquired the images, on a different device from the device that acquired the images, or may be distributed among several distinct devices.

According to a further embodiment of the present invention, the method step further comprises filtering a database for anatomical annotation markers matching the clinical context associated with the image file. Once the match is detected, it is only the matching markers that are provided for selection in the user interface. This may result in yet further speeding-up of the exam procedure as the medical practitioner is provided only with annotation markers relevant to the medical context—throughput is further enhanced because current systems provide usually vast number of potential annotation markers.

The invention further provides an apparatus implementing the above method along with a computer-readable medium and a program element suitable to implement the method on an appropriate system. In other words, the invention relates also to a computer program for a processing device, such that the method according to the invention might be executed on an appropriate system. The computer program is preferably loaded into a working memory of a data processor. The data processor is thus equipped to carry out the method of the invention. Further, the invention relates to a computer readable medium, such as a CD-ROM, at which the computer program may be stored. However, the computer program may also be presented over a network like the worldwide web and can be downloaded into the working memory of a data processor from such a network.

In sum, the proposed method and apparatus solves the problem in the art identified above by constraining all possible diagnostic findings to those appropriate for the specific anatomic data (“clinical context”). As the image acquisition procedure is being guided by the protocol, the clinical context for each imaging step (“view”) it is known and may be attached to each acquired image without operator involvement at the time of the exam. In yet other words, the proposed method and system allows making available only those diagnostic findings that are clinically relevant to any one of the views.

The imaging post-processing may be further facilitated by providing the opportunity to easily create dynamic links between the diagnostic findings and the specific images that provide evidence for the statement. Being able to log the diagnostic findings at the time the images are acquired may allow for the links to be saved along with the findings. The findings and the images linked thereto (the “tuples”) may then be stored using standard DICOM technology or by any other means.

The invention therefore furthers the paradigm of “report-as-you-go” technology. Medical reports are virtually created “on the fly” during the image acquisition procedure. Reports may either be “preliminary” reports by operators of varying skill levels or “final” reports if exam acquisition is being performed by a physician with signature authority.

By constraining all available diagnostic findings to the critical few makes it more practical to create preliminary or final reports during exam acquisition and, if need be, to link each of those diagnostic statement to one or more images representative of the observation or to link one of the images to one or more of the diagnostic findings applicable.

It has to be noted that aspects and embodiments of the present invention have been described with reference to different subject-matters. In particular, some embodiments have been described with reference to the method type claims whereas other embodiments have been described with reference to apparatus type claims. However, a person skilled in the art will gather from the above and the following description that, unless other notified, in addition to any combination of features belonging to one type of subject-matter also any combination between features relating to different subject-matters, in particular between features of the apparatus type claims and features of the method type claims, is considered to be disclosed with this application.

### BRIEF DESCRIPTION OF THE DRAWINGS

Embodiments of the invention will now be described by way of example only with reference to the following figures. The figures are schematic and not to scale with like numerals referring to like structures across the figures, wherein:

FIG. 1 shows an apparatus for processing a medical image file according to one embodiment of the present invention and in communication with a medical imaging modality;

FIG. 2 shows a schematic block diagram of the operation of the apparatus in FIG. 1;

FIG. 3 shows a schematic block diagram of an operation according to a second embodiment of the apparatus in FIG. 1;

FIG. 4 shows a schematic block diagram of an operation according to a third embodiment of the apparatus in FIG. 1.

### DETAILED DESCRIPTION OF EMBODIMENTS

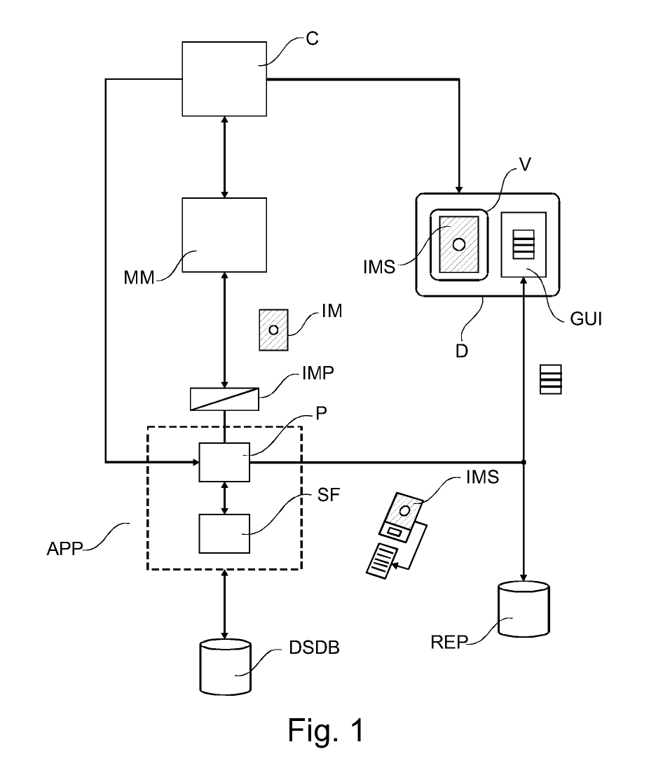

FIG. 1 shows an apparatus APP for processing a medical image file IM according to one embodiment of the present invention.

The apparatus APP is in communication with a computer C. The computer C controls a medical imaging modality MM. The imaging modality is for example an X-ray or ultrasound machine.

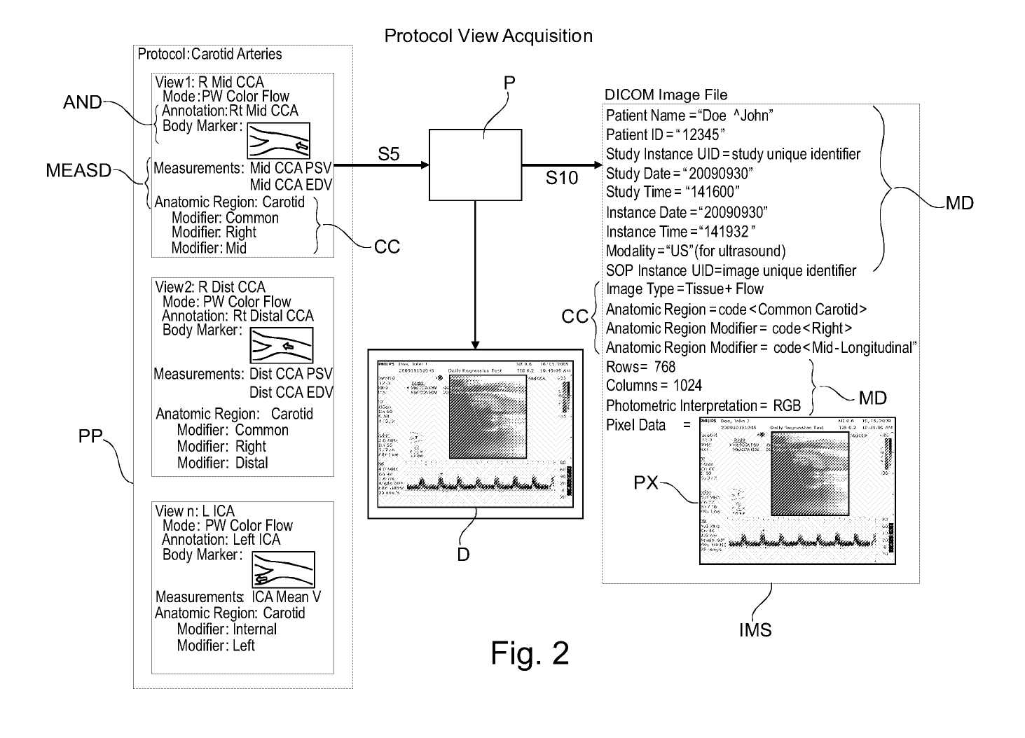

The computer C controls or guides an imaging procedure on the imaging modality MM by using a protocol PP, shown in FIG. 2.

The protocol PP defines a number of steps to be performed by the imaging modality MM in order to acquire each medical image file IM. Upon completion of this protocol controlled or guided imaging procedure the acquired image file IM is dispatched to the image processing apparatus APP.

The apparatus APP has a suitable interface IMP for receiving the acquired image file IM. The apparatus APP comprises a processor P and a filter algorithm FA. As will be explained in more detail in FIG. 2, the processor P produces on the basis of the received image file IM and the protocol PP a “smart” image file IMS.

The operations of the apparatus APP effects matching up the smart image file IMS with one or more diagnostic findings stored in a diagnostic findings database DSDB. The matching templates are retrieved by using the filter algorithm FA.

The apparatus APP outputs the smart image file IMS now in association with one or more diagnostic findings that are most relevant to the clinical context of the image. The image together with the set of most relevant diagnostic findings may then be dispatched for view on a display screen D. The computer C runs a suitable viewer program to view smart image IMS. The display D further displays a graphical user interface GUI providing the matching most relevant diagnostic findings for selection to the operator (for example a technologist or a reviewing physician) of the imaging modality MM.

Again with reference to FIG. 2, the operation of the apparatus APP will now be explained in more detail.

The protocol PP is a predefined set of imaging steps or “views” making up the medical imaging procedure. Each protocol view specifies the conditions under which an image is acquired including for example name and/or coded concepts specifying clinical context CC of the image, graphical and textual labelling of the image including annotation text and body markers, quantifications or measurements to be performed on the image, and control image setting in relation to the imaging device MM, including imaging mode, imaging type and other control settings. In other words, each view in the protocol defines the specific tissue organ be examined and optionally one or more measurements being obtained with each image in the procedure.

The left hand side of FIG. 2 shows a schematic description of the protocol PP. The Protocol PP is for example a structured file having a number of data fields, coded in a mark-up language such as XML.

Each of the protocol data fields specify the views (in FIG. 2, views 1 through n) of the imaging procedure to be performed at the imaging modality MM when acquiring the image files IM.

Each view-data-field optionally has sub-data-fields specifying the measurement data MEASD that may be taken from the acquired image IM in that view. Other sub-data-fields comprise information on annotation markers that may be used to annotate the acquired images IM in the respective view. The annotation data AND comprise references to graphical thumbnails for example GIF files suitable as body markers.

Each view-data-field further comprises one or more sub-data-field comprising clinical context data CC. For example, the clinical context data CC specifies a portion of an anatomical object, such as the carotid artery, which is to be represented on the image when acquired in the respective view.

As an image corresponding to a view in the protocol PP is acquired, the processor P copies the clinical context from the selected view in step S5 and saves the clinical context with the acquired medical image in step S10 so as to obtain a “smart” image file IMS. The image file IMS is smart because it “knows” the clinical context it represents.

The smart image IMS may be saved in a proprietary format or in a standard format, such as DICOM. According to the invention the clinical context data CC from the protocol is copied into a specially prepared data field earmarked for this purpose in the smart image IMS. The processor P effects allocating memory space to extend the acquired image IM file prior to in-copying the clinical context data CC.

As shown on the right-hand side of FIG. 2, the smart image file IMS comprises the actual picture or volume data samples PX (also known as pixels or voxels) and a header comprising the data fields holding metadata MD and the adjoined data field holding the copied clinical context data CC.

The clinical context CC for example comprises in DICOM coded form a triple of a textual description (“common carotid” in the example of FIG. 2) of the anatomic object “anatomic region” represented by the acquired image, and “region modifiers” specifying parts of the anatomic region that has been acquired in the respective view. The clinical context data CC is specific to each one of the views, in this case to view 1.

The imaging procedure at the modality MM then proceeds through the other views “view 2” through “view n”, each corresponding to different anatomic data associated with any one of those views, which anatomic data are then copied likewise by the processor P into the respective one of acquired image files to so obtain a set of further smart image files.

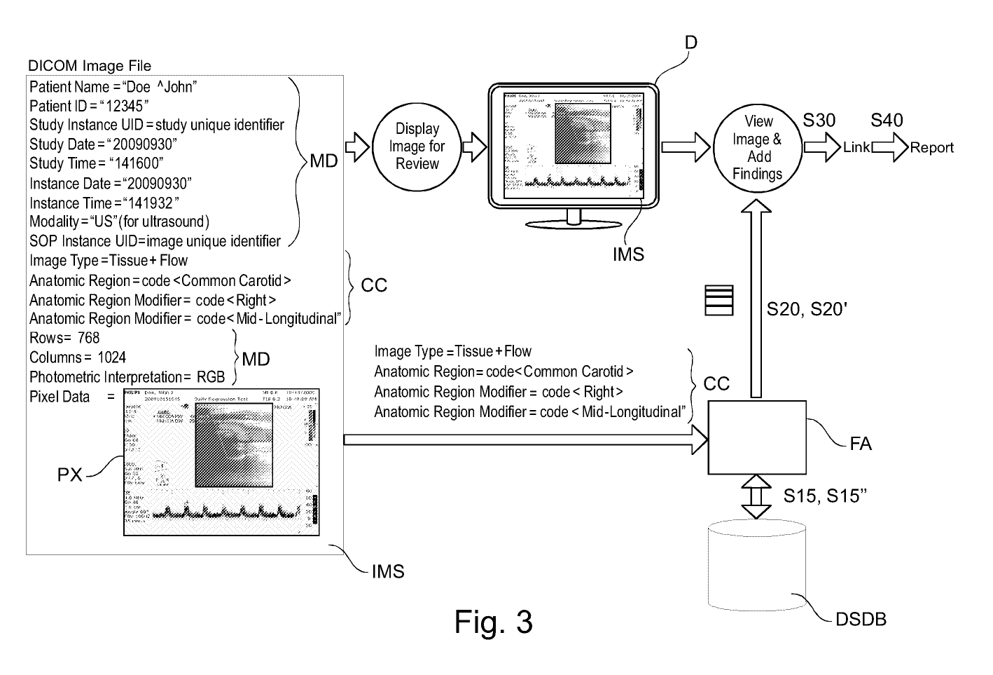

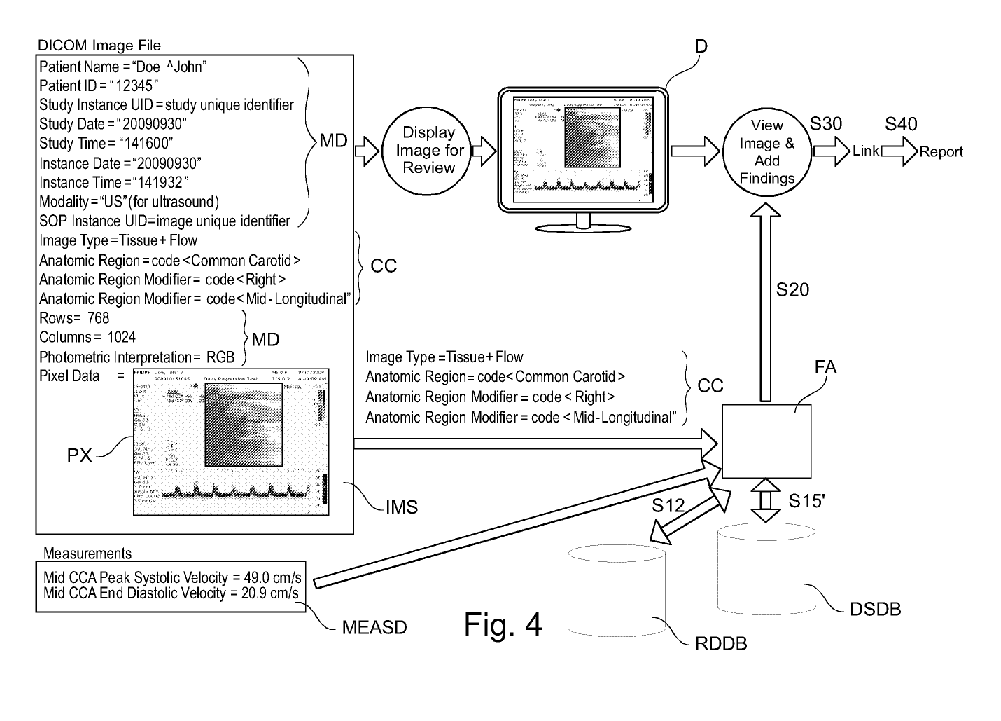

To sum up, the smart images so obtained have effectively been “enriched” with clinical context data coded in the protocol to facilitate post-processing steps to be carried out with greater efficiency as will be explained now in FIGS. 3 and 4. In other words, the invention embeds clinical context taken from the protocol into the acquired images to optimize downstream workflow to optimize image post-processing.

FIG. 3 shows the operation according to a second embodiment and the corresponding process steps executed by the image process apparatus APP when post-processing the acquired smart image IMS.

The post-processing steps in FIG. 3 involve retrieving and associating an appropriate set of diagnostic findings stored in the diagnostic findings database DSDB with the smart image file IMS.

The apparatus uses thereby the clinical context data CC copied to the smart image IMS. The filter algorithm FA is a software or hardware module using pattern matching techniques to compare the clinical context of the acquired image with the collection of clinical contexts or subsets of clinical contexts for which each diagnostic finding in the diagnostic findings database DSDB applies and passing through only those diagnostic findings that are considered by the filter algorithm FA to match the clinical context of the image. The filter algorithm FA may be implemented using any technique known to those skilled in the art.

The records in the diagnostic findings database DSDB comprise a number of those matchable coded identifiers each one associated with either the diagnostic statement itself or a file path which will then allow the processor P to retrieve the corresponding database findings once a match has been detected. The database DSDB provides a “library” of the coded diagnostic findings in the diagnostic findings database DSDB indexed to relevant coded indicia of the clinical context data CC.

The one or more matching diagnostic findings are then retrieved and provided in step S20 for selection on the graphical user interface GUI by any of a number of possible means. The graphical user interface GUI is displayed in a window (“widget”) on the display screen D alongside a window of the viewer which displays the pixel or voxel data PX of the smart image file IMS. Alternatively, the matching diagnostic findings and the pixel or voxel data are displayed in different panes of a master window. Alternatively, it is not the diagnostic findings themselves that are displayed in the window but icons arranged as button widgets indicative to the findings. This may be by displaying on the icon the first few words of the respective diagnostic finding code or associated code meaning text.

The operator may then use a pointer device such as a mouse to select any one of the icons representative of the matched diagnostic findings. Upon response to such a user “mouse click” the processor P is operational in bundling up in step S30 the user selected matching diagnostic findings with the displayed smart image file IMS to form an image-statement “tuple”. The bundling up is effected by representing in memory the image-findings as a suitable data structure such as an associative array. In the associative array the current smart image file IMS is linked or associated with the one or more user selected diagnostic findings; conversely, each selected diagnostic finding may be associated with one or more images.

The link thus created may be used to view the image(s) corresponding to a diagnostic finding interactively or to embed evidential images into the displayable or printable report along with the diagnostic findings. It is noted that the user may specify at the time a diagnostic finding is selected whether or not a particular image is to be copied onto the displayable or printable report, in case not all linked images are to be included on the report. Alternatively, this designation may be deferred until all findings are formatted into a report as described below.

The associative array may then be stored away of further processing in a repository such as a PACS. One such means by which this may be done is through the use of DICOM Structured Reporting “spatial coordinates” known as SCOORD.

Upon later retrieval for display in a viewer program of any one of the smart image files the associated diagnostic findings may then be shown on the display D alongside the pixel or voxel data of the image file IMS to facilitate review of the diagnostic findings in a subsequent offline session. In other words, the image process apparatus APP facilitates offline review applications to quickly guide the reviewing physician towards the most appropriate diagnostic findings as he sets out to build the final medical report in step S40.

Steps S15, S20 and S30 may be executed by the processor P whilst the pixel or voxel data PX of the smart image IMS is displayed on the screen D. Preferably, the association of the diagnostic findings to the smart image file IMF is effected whilst the sonographer is viewing the current image file IMS on the display screen.

Clicking on a corresponding icon in the graphical user interface user interface GUI, the sonographer may issue a command to effect the one or more smart images IMS in the associative array and the respective ones of the diagnostic findings to be assembled in step S40 into a medical report.

The actual assembly of the document may be affected by a suitable back-end downstream software tool. For example, using a word processing software as a back-end, suitable macros may be coded to copy-paste the smart image files from the associative array into a word document alongside the associated diagnostic findings to create the medical report as a word document. The medical report so obtained may then be converted into PDF-file.

According to one embodiment prior to providing in S20 the matching diagnostic findings are ranked based on their clinical anatomic and/or physiological relevance using a weight function indicating the degree of applicability. In this case the graphical user interface provides the functionality of configuring the graphical user interface GUI to display only the first N diagnostic findings from the sequence of relevance ranked findings matched. The user interface GUI then presents the relevant diagnostic statement ordered by highest weighted score and further displays other data as preferred by, for example, a sonographer. For example, all choices related to a valve jet may be presented together (degree of stenosis), all choices related to valve leaflet motion may be presented together (e.g. degree of prolapse), etc.

According to another embodiment the filtering in step S15′ by the filter algorithm FA may also be used to select those graphical annotation markers that are most appropriate for inclusion into the viewed smart image IMS given the clinical context data CC in the smart image IMS.

With reference to FIG. 4, the operation according to a third embodiment of the processor P will now be explained. When operating according to the third embodiment, the filter algorithm FA is filtering in step S15″ for the diagnostic findings by not only matching against the clinical context data CC but also against measurement data MEASD previously obtained by the technologist or physician from the displayed smart image IMS.

The measurement data MEASD may include, as an example, the peak systolic velocity (in this exemplary case, PSV=49 cm/s) in respect of the carotid artery represented by the pixel data PX in the smart image file IMS. The measurement data in MEASD is specified in the protocol PP.

The protocol specified measurement data MEASD is obtained automatically, semi-automatically or by the operator by using a mouse to specify coordinates representing a portion in the image to be measured. Geometric calculations on the specified coordinate points are then translated into the measurement data MEASD. The filter algorithm FA then compares in step S12 the measurement data MEASD against normal and abnormal values held in a reference data database RDDB. The filter algorithm FA then establishes a deviation value of the measured data MEASD against the normal and abnormal values, wherein the abnormal values may include the degree of abnormality, for example ‘mild’, ‘moderate’ or ‘severe’. Subsequently, the filter algorithm FM returns the deviation value to execute a combined filtering in the diagnostic findings database DSDB for the diagnostic findings. In other words, the filter algorithm FA not only matches solely on the basis of the clinical context data but also matches in respect of the deviation values. According to this embodiment, the coded diagnostic findings in the database DSDB are not only associated with coded anatomic data identifiers but also with numerical data so that the filter can execute the combined filtering.

In the event the filter algorithm FA detects such a combined match the relevancy ranking of the matched diagnostic findings is established and the first N findings in the relevance ranked sequence of matching diagnostic findings is provided on the graphical user interface GUI for selection to the sonographer. According to this embodiment, the diagnostic findings are tailored to the specific anatomy having the measured properties.

According to a further embodiment of the present invention, the operation of the filter algorithm FA may be augmented by including in addition to the clinical context data from the protocol and deviation values of measurements made on the image, additional suitably coded clinical context data obtained from sources other than the protocol PP, including for example the type of exam being performed, patient demographics (such as sex or age), patient history of disease or pregnancy (e.g., findings associated with rejection of a transplanted organ are relevant only in transplant patients, and obstetrical findings may depend on gestational age), previously selected diagnostic statements, or statements from previous diagnostic reports.

According to a further embodiment, the filter algorithm FA provides filter functionality filtering based on a combination of any of the previous filtering parameters.

It should be noted that the term “comprising” does not exclude other elements or steps and that the indefinite article “a” or “an” does not exclude the plural. Also elements described in association with different embodiments may be combined. It should also be noted that reference signs in the claims shall not be construed as limiting the scope of the claims.

1. A method of processing a medical image file acquired in a protocol guided imaging procedure, the method comprising the steps of:
identifying (S5) in the protocol clinical context data pertinent to an anatomical object represented by the acquired image file;
from the protocol, attaching (S10) the identified clinical context data to the acquired image file.

2. A method of claim 1, further comprising the step of:
constraining behaviors based on the identified clinical context, which behaviors are available within related system functionality that affects the viewing of, annotation of, processing of, or reporting of clinical conclusions related to the acquired image.

3. The method of claim 1, further comprising the steps of:
filtering (S15) in a database for a set of potential diagnostic findings matching the clinical context data attached to the image file;
if a match is detected, providing (S20) for selection in a user interface only the matching diagnostic findings.

4. The method of claim 3, further comprising the step of:
associating (S30) one or more specific selections from the matching set of diagnostic findings with the image file to form one or more image-to-finding tuple's.

5. The method of claim 4, further comprising the step of:
assembling (S40) the image-to-finding tuple's into a medical report.

6. The method of claim 1, further comprising the steps of:
comparing (S12) measurement data taken from the object in the image file against normal and abnormal values to categorize the deviation, filtering (S15′) a database for a set of diagnostic findings matching both, the clinical context data attached to the image file and the categorization of the deviation.

7. The method of claim 1, further comprising the step of:
filtering (S15″) in a database for a textual and/or graphical annotation matching the clinical context data attached to the image file;
if a match is detected, providing (S20′) for selection in a user interface only the matching textual and/or graphical annotations.

8. The method of claim 1, wherein any one of the steps are performed whilst the acquired image file is being displayed on a screen.

9. An apparatus for processing a medical image file acquired by a protocol guided imaging procedure, the apparatus comprising:
an interface (IMP) configured to receive the acquired image file;
a processor (P) configured to identify in the protocol clinical context data pertinent to an anatomical object represented by the acquired image file and to attach from the protocol the identified clinical context data to the acquired image file.

10. The apparatus of claim 9, further comprising
a filter algorithm (FA) programmed to filter a database (DSDB) for a set of potential diagnostic findings matching the clinical context data attached to the image file;
a graphical user interface (GUI) arranged to provide for selection of only the matching findings detected by the filter algorithm (FA).

11. The apparatus of claim 10, wherein the graphical user interface (GUI) is further arranged to associate, responsive to a user input, the matching findings with the image file to form an image-to-finding tuple suitable to be stored.

12. The apparatus of claim 9, wherein the filter algorithm (FA) is further programmed to filter the database (DB) for graphical annotation markers relevant to the clinical context corresponding to the copied clinical context data from which an operator may select one or more markers suitable for display on the image file.

13. The apparatus of claim 9, further comprising a pointer device (PD) configured to take measurement data from the object in the image file, the processor (P) further configured to compare the measurement data against normal values to obtain a deviation value, wherein the filter algorithm (FA) is further programmed to filter a database (DB) for the textual template to match both, the copied anatomical data and the deviation value.

14. The apparatus of claim 9, wherein the apparatus is arranged to be operational whilst the acquired image file is being displayed on a screen.

15. A computer program element containing sets of instructions which, when executed on a computer serve to control the computer to perform the method of any one of claims 1 to 8.
